(19) United States
(12) Patent Application Publication
(10) Pub. No.: US 2006/0122301 A1
(43) Pub. Date: Jun. 8, 2006

(54) Fluorinated divinyl ethers

(75) Inventors: Haridasan K. Nair, Williamsville, NY (US); David Nalewajek, West Seneca, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/006,879

(22) Filed: Dec. 8, 2004

(51) Int. Cl. C08K 3/26

(52) U.S. Cl. 524/425; 526/313; 524/493; 524/435; 524/447; 526/247; 526/348.1; 568/674

(57) ABSTRACT

Fluorinated divinyl ethers having structures according to Formula I or II:
R_{f}CX═CY—O—Z—O—CH═CH₂ (I)
R_{f}CX═CY—O—M—O—CY═CXR_{f} (II)
wherein R_{f} is fluorine or a C₁-C₂₀ fluorinated alkyl; X and Y are independently hydrogen, a halogen, or a C₁-C₂₀ fluorinated alkylene; Z is a C₁-C₂₀ alkylene, C₃-C₁₀ cycloalkylene, four to ten ring member aromatic and non-aromatic heterocycloalkylene, C₆-C₁₅ arylene, or C₇-C₂₀ arylalkylene; and M is a C₁-C₂₀ alkylene, C₃-C₁₈ fluorinated alkylene provided that the chain does not terminate with -CHF- or -CF₂-, or a C₃-C₁₈ diol having the formula —HO—CH₂—(CF₂)ₙ—CH₂—OH— wherein n is an integer from 1 to 16. Curable compositions, polymers, films, coatings, and optical devices comprising fluorinated divinyl ether compounds are also disclosed as well as processes for producing optical devices from the fluorinated divinyl ether compounds and processes for producing the fluorinated divinyl ethers.

### FIELD OF INVENTION

The present invention relates to fluorinated divinyl ethers. More specifically, the invention relates to a family of fluorinated divinyl ethers, their uses, and the products resulting therefrom.

### BACKGROUND OF INVENTION

Few divinyl ethers are known in the art. They are used for a variety applications such as in surface coating formulations for various materials such as metal, plastic, silica, and the like. For example, U.S. Pat. No. 4,908,277 (Tsunashima, et al.) discloses divinyl epoxy ethers for application in adhesive protective coatings suitable for thin layer films. In addition, U.S. Pat. No. 5,158,811 (Liu) describes divinyl ether siloxanes for coating various metal and plastic surfaces. Divinyl ethers of diols are reported be good cross linkers for polymers, U.S. Pat. No. 6,093,855 (Lorenz). The use of polyacetal-based divinyl ethers in medicine for the controlled release of drugs is described in U.S. Pat. No. 5,374,681 (Kroner, et al.).

It is well known that incorporation of fluorine into polymers has many benefits. Fluorinated polymers offer advantageous properties such as excellent chemical and thermal stability, good weathering and humidity resistance, low surface tension, low refractive index, and low absorption in the 1300-1610 nm electromagnetic spectral region. This low absorption of fluoropolymers in the 1300-1610 nm spectral region permits their use as coatings for optical fibers and in the fabrication of optical wave guides.

Although fluorinated vinyl ethers are known in the art, there are few examples of fluorinated divinyl ethers. There remains a need for novel fluorinated divinyl ethers for various commercial applications.

### DESCRIPTION OF INVENTION AND PREFERRED EMBODIMENTS

The present invention provides for a family of fluorinated divinyl ether compounds which are useful in the manufacturing or synthesis of other compounds, including polymeric compounds, that have a wide variety of uses. The fluorinated divinyl ether compounds of the present invention exhibit the beneficial properties of fluorinated vinyl ether compounds, but offer a superior polymerization rate, faster cure rate, and better chemical and thermal stability.

According to the present invention, fluorinated divinyl ethers compounds are provided having the structure of either Formula I or II:
R_{f}CX═CY—O—Z—O—CH═CH₂ (I)
R_{f}CX═CY—O—M—O—CY═CXR_{f} (II)
wherein X and Y are independently hydrogen, fluorine, chlorine, bromine, iodine, or a C₁-C₂₀ straight chained or branched fluorinated alkylene; R_{f} is fluorine or a C₁-C₂₀ straight or branched-chain fluorinated alkyl; M is a straight or branched-chain C₁-C₂₀ alkylene, a C₃-C₁₈ diol having the formula —HO—CH₂—(CF₂)ₙ—CH₂—OH— where n is an integer from 1 to 16, or a straight or branched-chain C₃-C₁₈ fluorinated alkylene provided that the chain does not terminate with —CFH— or —CF₂—; and Z is a straight or branched-chain C₁-C₂₀ alkylene, a C₃-C₁₀ unsubstituted or substituted cycloalkylene, a four to ten ring member aromatic or non-aromatic heterocycloalkene, a C₆-C₁₅ unsubstituted or substituted arylene, or a C₇-C₂₀ unsubstituted or substituted arylalkylene. As used herein, the term alkylene, fluorinated alkylene, cycloalkylene, heterocycloalkylene, arylene, or aryalkylene refers to the divalent organic radical derivatives of the specified group.

Another aspect of the present invention provides curable compositions that contain a curable component that includes at least one compound having the structure of Formulas I or II, supra. The curable compositions will contain between 0.01% to about 99% by weight of at least one compound having the structure of Formula I or II. A preferred curable composition includes curable compositions combining at least one compound having the structure of Formula I or II with an initiator compound. Photocurable compounds in which the initiator compound is an actinic radiation photoinitiator compound are even more preferred.

The photocurable compositions of the present invention are useful in the manufacture of optical devices having light transmissive regions. Therefore, another aspect of the present invention provides a process for producing an optical device employing the steps of: (a) applying a layer of the photocurable composition of the invention onto a substrate; (b) imagewise exposing the photocurable composition of the invention to actinic radiation to form exposed and non-exposed areas on the substrate; and (c) removing the imagewise non-exposed areas while leaving the imagewise exposed areas on the substrate.

A further aspect of this invention includes articles of manufacture with polymeric portions from the fluorinated divinyl ether compounds of the present invention. A preferred embodiment of this aspect of the invention comprises the use of the fluorinated divinyl ether compounds of the present invention in the preparation of a light transmissive component of an optical device, particularly waveguides.

Still another object of the invention provides polymeric films comprising at least one compound having the structure of Formula I or II. In one embodiment, the film is incorporated as a surface layer on a substrate made of various materials such as metals, alloys, polymers, paper, fibers, and the like. The term film, as used herein, refers to a thin sheet or strip of flexible material. The term coating, as used herein, refers to a thin layer of a substance spread over at least a portion of the surface of a substrate.

In one aspect of the present invention, the monomer compounds having the structure of either Formula I or II or both are polymerized or cured to form polymers. Therefore, a further aspect of the invention provides for polymers with one or more divinyl ether repeating units, alone or with other repeating units, wherein at least one of the divinyl ether repeating units as polymerized has at least one of the structures depicted in Formulas III through VII: 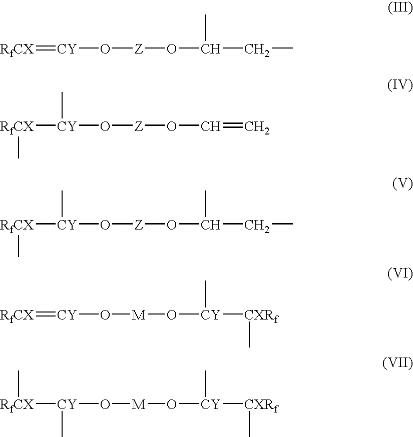
wherein X, Y, M, Z, and R_{f} are the same as described with respect to Formulas I and II.

In one embodiment, polymers according to the present invention are provided that comprise only divinyl ether repeating units of one compound of either Formula I or II, resulting in a homopolyer. In another embodiment, the polymers according to the present invention are provided that comprise divinyl ether repeating units of two or more different compounds according to either Formulas I or II or according to both Formulas I and II, resulting in a copolymer. In a further embodiment, polymers according to the present invention include one or more additional repeating units derived from other monomers, oligomers, or polymer compounds that have been copolymerized with one or more divinyl ether compounds of either or both Formulas I and II.

In Formulas I and II, R_{f} as a fluorinated C₁-C₂₀ straight or branched-chain alkyl may be, for example, fluoromethyl, difluoromethyl, trifluoromethyl, fluoroethyl, difluoroethyl, trifluoroethyl, pentafluoroethyl, perfluoropropyl, perfluorobutyl, perfluoropentyl, perfluorohexyl, and the like. Preferably, R_{f} is trifluoromethyl or fluorine.

In Formulas I and II, M as a C₁-C₂₀ straight or branched-chain alkylene may be, for example, —CH₂—, —CH₂—CH₂—, n-propylene, isopropylene, n-butylene, isobutylene, tert-butylene, n-pentylene, neopentylene, n-hexylene, n-heptylene, n-octylene, 2-ethylhexylene, and the like. In a preferred class of alkylenes, M is a straight chain C₁-C₆ alkylene, especially ethylene and butylene.

Additionally, M as a fluorinated C₃-C₁₈ straight or branched-chain alkylene may be, for example, —CH₂—CFH—CH₂—, 2,3-difluorobutylene, 2,3,4-trifluoropentylene, 2,4-difluoropentylene, 2,5-difluorohexalene, and the like. Preferably, M is —CH₂—(CF₂)ₙ—CH₂— wherein n is an integer from 1 to 16.

M as a fluorinated C₃-C₁₈ diol may be, for example, —HO—CH₂—(CF₂)₂—CH₂—OH—, 2,2,3,3,4,4-Hexafluoro-1,5-pentylenediol, 2,2,3,3,4,4,5,5-Octafluoro-1,6-hexylenediol, and the like.

In Formulas I and II, Z as a C₁-C₂₀ straight or branched-chain alkylene may be, for example, —CH₂—, —CH₂CH₂—, n-propylene, isopropylene, n-butylene, isobutylene, tert-butylene, n-pentylene, neopentylene, n-hexylene, n-heptylene, n-octylene, 2-ethylhexylene, and the like. Preferably, Z is a C₂-C₆ straight or branched-chain alkylene, and more preferably ethylene or butylene.

Also, Z as a C₃-C₁₀ substituted or unsubstituted cycloalkylene may be, for example, cyclopropylene, cyclobutylene, cyclopentylene, methylcyclopentylene, cyclohexylene, methylcyclohexylene dimethylcyclohexylene, cycloheptylene, cyclooctylene, and the like. In a preferred class of cycloalkylenes, Z is a C₆-C₁₀ substituted or unsubstituted cycloalkylene, more preferably a C₆-C₈ substituted or unsubstituted cycloalkylene, and even more preferably 1,4-dimethylcyclohexylene.

Z as a four to ten ring member heterocycloalkylene may include known heterocyclic atoms such as N, O, and S.

Z as a C₆-C₁₅ aryl may be, for example, benzylene, phenylene, o-tolylene, m-tolylene, p-tolylene, o-xylylene, m-xylylene, p-xylylene, alpha-naphthylene, beta naphthylene, and the like.

Z as a C₇-C₂₀ arylalkylene may be, for example, 4-methylphenylene, o-methylphenylene, p-methylphenylene, diphenyl-methylene, 2-phenylethylene, 2-phenylpropylene, 3-phenylpropylene, and the like.

Furthermore, in certain preferred embodiments, X is the same as Y.

The compounds of Formulas I and II may exist in isomeric form. For example, the position of the R_{f} group in a compound according to Formulas I or II may be either: 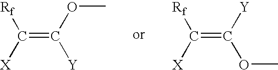
In addition, cis and trans geometric isomers may also be present in the subject compounds. All racemic and isomer forms of the compounds of Formulas I and II, including pure enantiomeric, racemic, and geometric isomers and mixtures thereof, are within the scope of this invention.

The compounds of Formula I can be prepared by reacting a hydroxyvinyl ether, such as HO—Z—O—CH═CH₂ with a fluoroolefin, such as R_{f}CX═CYW wherein X, Y, and W are independently hydrogen, fluorine, chlorine, bromine, iodine, or a C₁ to C₂₀ straight or branched-chain fluorinated alkylene group provided that at least one of Y or W is a halogen. In the presence of a weak base catalyst, one would expect the major product to be the simple addition product, such as the monovinyl ether R_{f}CHX—CYW—O—Z—O—CH═CH₂. However, the addition of HO—Z—O—CH═CH₂ to R_{f}CX═CYW in the presence of catalytic amount of Cs₂CO₃ or K₂CO₃ unexpectedly results in the formation of R_{f}CX═CY—O—Z—O—CH═CH₂ (cis+trans mixture) as the major product, as depicted in the following equation (eq 1):
R_{f}CX═CYW+HO—Z—O—CH═CH₂→R_{f}CX═CY—O—Z—O—CH═CH₂ (major)+R_{f}CHXCYW—O—Z—O—CH═CH₂ (minor) Eq. 1

This reaction can be conducted utilizing a dipolar aprotic organic solvent such as acetonitrile, or an aqueous solvent such as aqueous alkali and alkaline metal hydroxides. In some processes, the use of aqueous solvents is more economically and environmentally advantageous compared to the use of organic solvents. One example of the use of an aqueous solvent involves the addition of olefins to a stirred mixture of an appropriate hydroxyl vinyl ether and aqueous sodium hydroxide (approximately 4-10% by weight) solution in the presence of a phase transfer catalyst such as Aliquat® 336 to yield the divinyl ethers. In this example, the amount of base utilized is determined by mole equivalency (not by catalytic amount) and should be 1-100% of the moles of the hydroxyl vinyl ether or the amount necessary to neutralize acids generated by the reaction.

For purposes of the present invention, a phase transfer catalyst is a substance that facilitates the transfer of ionic compounds (e.g., reactants or components) into an organic phase from, e.g., a water phase. In the present invention, an aqueous or inorganic phase is present as a consequence of the alkali metal hydroxide and an organic phase is present as a result of the fluorocarbon. The phase transfer catalyst facilitates the reaction of these dissimilar and incompatible components. The phase transfer catalyst can be ionic or neutral and is selected from the group consisting of crown ethers, onium salts, and cryptates. An effective amount of the phase transfer catalyst should be used in order to effect the desired reaction. Such an amount can be determined by limited experimentation once the reactants, process conditions and phase transfer catalyst are selected.

Examples of crown ethers that may be used as a phase transfer catalyst include, but are note limited to, 18-crown-6, especially in combination with potassium hydroxide; 15-crown-5, especially in combination with sodium hydroxide; 12-crown-4, especially in combination with lithium hydroxide. Derivatives of the above crown ethers are also useful, e.g., dibenzo-18-crown-6, dicyclohexano-18-crown-6, and dibenzo-24-crown-8 as well as 12-crown-4. Other polyethers particularly useful for alkali metal compounds, and especially for lithium, are described in U.S. Pat. No. 4,560,759 which is incorporated herein by reference to the extent permitted.

Examples of onium salts that may be used as a phase transfer catalysts include, but are not limited to, tetramethylammonium chloride, tetramethylammonium bromide, benzyltriethylammonium chloride, methyltrioctylammonium chloride (available commercially under the brands Aliquat 336 and Adogen 464), tetra-n-butylammonium chloride, tetra-n-butylammonium bromide, tetra-n-butylammonium hydrogen sulfate, tetra-n-butylphosphonium chloride, tetraphenylphosphonium bromide, tetraphenylphosphonium chloride, triphenylmethylphosphonium bromide and triphenylmethylphosphonium chloride. Among them, benzyltriethylammonium chloride is preferred for use under strongly basic conditions.

A non-limiting example of a cryptate that may be used as a phase transfer catalyst is 2.2.2-cryptate (4,7,13,16,21,24-hexaoxa-1,10-diasabicyclo-(8.8.8)hexacosane, available under the brand names Cryptand 222 and Kryptofix 222).

Combinations of phase transfer catalysts from within one of the groups described above may also be useful as well as combinations or mixtures from more than one group, for example, crown ethers and oniums, or from more than two of the groups, e.g., quaternary phosphonium salts, quaternary ammonium salts, and crown ethers.

In a similar manner, the divinyl ethers of Formula II are prepared as depicted below:
R_{f}CX═CYW+HO—M—OH→R_{f}—CX═CY—O—M—O—CY═CX—R_{f} Eq. 2

Many fluorolefins can be employed as R_{f}CX═CYW for this reaction. The preferred olefins are CF₃CH═CF₂, CF₃CH═CFH, CF₃CF═CFH, CF₃CH═CHCI, CF₃CBr═CF₂, CF₃Cl═CHCl, and the like, and CF₃(CF₂)ₙCF═CF₂ and CF₃(CF₂)ₙCF═CH, wherein n is an integer from 1 to 16. Many hydroxy vinyl ethers are commercially available (for example HO—(CH₂)₂—O—CH═CH₂, HO—(CH₂)₄—O—CH═CH₂, HO—Z—O—CH═CH₂, wherein Z is 1,4-dimethylcyclohexane, an aromatic group, and the like, are obtained from BASF) or can be obtained by recognized procedures in the art (see e.g., P. Fischer, Enol Ethers Structure, Synthesis and Reactions, in CHEMISTRY OF ETHERS, CROWN ETHERS, HYDROXYL GROUPS AND THEIR SULFUR ANALOGS (S. Patai, ed., Wiley, Chichester, UK, 1980) 761-920. Acetonitrile is the preferred organic solvent and aqueous sodium hydroxide is the preferred aqueous solvent. Many diols are commercially available from various vendors. A variety of bases can be used such as metal carbonates (K₂CO₃, Cs₂CO₃), hydroxides of alkaline and alkaline earth metals, and the like. Organic bases such as trialklyamine, pyridine, and the like, may also be used provided that the reaction involves the use of an organic solvent.

The reaction is generally carried out under a nitrogen atmosphere with a temperature range from approximately −10 to −100° C. in a polar aprotic solvent such as acetonitrile. The reaction can also be carried out in an aqueous solvent such as sodium hydroxide in the presence of a phase transfer catalyst. Conventional work up such as phase separation, extraction, concentration, or distillation affords the crude product. Purification of the divinyl ether is generally accomplished by fractional distillation under reduced pressure.

Preferred divinyl ethers of the present invention include the following:
CF₃CH═CF—O—(CH₂)₂—O—CH═CH₂
CF₃CH═CF—O—(CH₂)₄—O—CH═CH₂
CF₃CH═CF—O—(CH₂)₂—O—CF═CHCF₃
CF₃CH═CF—O—(CH₂)₄—O—CF═CHCF₃
CF₃CH═CF—O—CH₂—(CF₂)ₙ—CH₂—O—CF═CHCF₃
CF₃CH═CF—O—Z—O—CH═CH₂
CF₃CH═CH—O—(CH₂)₂—O—CH═CH₂
CF₃CH═CH—O—(CH₂)₄—O—CH═CH₂
CF₃CH═CH—O—(CH₂)₂—O—CH═CHCF₃
CF₃CH═CH—O—CH₂—(CF₂)ₙ—CH₂—O—CH═CHCF₃
CF₃CH═CH—O—Z—O—CH═CH₂
wherein Z is 1,4-dimethylcyclohexylene and n is an integer from 1-16.

The compounds of the present invention will be useful in a number of applications, especially in such high technology areas as optical fibers, optical instruments and equipment, electronics, coatings, laminates, films, extruded or molded shapes and articles, and equipment exposed to a corrosive environment such as integrated circuit fabricating equipment.

It is well known that fluorinated monomers may be used for coating applications. See, for example, A. A. Wall, Fluoropolymers (Wiley-Interscience, 1972), and T. Deisenroth, Proc. Fluorine in Coatings II (Munich, 1997). Fluorinated polymers offer unique properties such as excellent chemical and thermal stability, good weathering and humidity resistance, low surface tension, low refractive index, and low absorption in the electromagnetic spectral region from 1300 to 1610 nm. The 1300-1610 nm region of the electromagnetic spectrum is particularly useful for fiber optic telecommunication networks. Accordingly, the present invention provides for a curable composition comprising at least one compound having the structure of Formula I or II that can be cured to form polymers and polymeric coatings, such as coatings to coat optical fibers as well as to fabricate optical waveguides.

The compounds of the present invention are also characterized by the ability to polymerize to form polymeric coatings that, upon curing, possess unique and useful surface properties including excellent surface wetting and low surface tension prior to curing, and low surface energy, low friction and high slip, low flammability, high chemical resistance, and excellent moisture resistance after curing. It is believed that the desirable surface properties are the result of the fluonrne-containing moieties migrating to the surface of cured coatings of the monomer compound, which contribute protective properties to the coating, as well. The fluorine-containing moieties also contribute surfactant-like qualities to the monomer compound that provide better flow, leveling and wetting, which is desirable for coating and ink compositions. Therefore, in addition to optical applications, the curable compositions of the invention containing the vinyl monomer of Formulas I or II find utility in numerous other areas, including, but not limited to, coatings, inks, photoresists, films, fibers, adhesives, insulators, laminates, elastomers, foams, molds and release coatings. For example, coatings derived from compounds of the present invention may be applied to encapsulate, for example, capacitors, resistors, and integrated circuits, for the purpose protecting them from a harmful environment or to provide a highly dielectric layer; to plastics sheets or metal foils for the purpose of protecting them from damage or for making laminates; to interior walls of reactors, especially those employed in highly corrosive reaction environments wherein concentrated acids or hydrofluoric acid are used, so as to protect them from corrosion; to light-transmissive devices such as optical lenses, prisms, and glazings to impart to them improved abrasion resistance or resistance against damage from corrosive environments; and to recording heads, disks, and tapes and to components of radio and microwave receiving equipment such as antenna dishes, etc., to protect them from physical or environmental damage.

Various curable formulations derived from vinyl ethers in general are described in U.S. Pat. No. 6,466,730 (Nair, et. al). It is well known in the art that vinyl ethers in general can be cured thermally or by actinic radiation. Actinic radiation such as UV light permits fast curing. UV curable compositions containing fluorinated monomers, oligomers, and polymers have been widely reported. See, for example, J. Pacansky, Progress in Organic Coatings, Vol. 18 (1990) 79 and R. Bongiovanni, Progress in Organic Coatings, Vol. 36 (1999) 70. These compositions comprise fluorinated vinyl ethers and at least one photoinitiator. Divinyl ethers of present invention can be formulated in a variety of ways and can be cured by procedures recognized in the art. See, for example, E. V. Sitzman et al., Radtech 1998 Conf. Proc. (1998) 72-82; U.S. Pat. No. 6,291,704 (Anderson, et al.) and U.S. Patent No. 6,308,001 (Nair, et al.).

Compositions of the present invention may be cured by the application of heat energy or exposure to actinic radiation. Initiator and photoinitiator compounds may also be employed. Microwave radiation may be used to apply heat to the composition. The compositions may also be catalytically cured without application of heat or exposure to actinic radiation, for example, by using an effective amount of a Lewis Acid catalyst, such as BF₃.

The amount of curable component in the curable compositions may vary widely. Depending upon the application, the component is present in an amount of from about 0.01 to about 99% by weight of the overall composition. For applications which rely upon physical properties of the curable compound other than surface properties, the curable component is preferably present in the curable composition at a level of at least about 35% by weight. In a preferred embodiment, the curable component is present in an amount of from about 80 to about 99% by weight, and, more preferably, from about 95 to about 99% by weight of the overall composition. Photocurable compositions contain an amount of the curable component within the foregoing ranges that is sufficient to photocure and provide image differentiation upon exposure to sufficient actinic radiation.

For applications which rely upon the ability of the curable component to modify the surface properties of other polymer systems, the curable component is preferably present in the curable composition at a level between about 0.10% and about 2.00% by weight. For these embodiments, a level of about 0.50% by weight is more preferred.

In addition to the compounds of Formula I and II, other curable compounds which are known in the art may be incorporated into the curable compositions of the present invention. These compounds include monomers, oligomers, and polymers that contain at least one terminal ethylenically unsaturated group and that are capable of forming a high molecular weight polymer by free radical initiated, chain propagating addition polymerization. Suitable monomers include, but are not limited to, ethers, esters, and partial esters of acrylic and methacrylic acids; aromatic and aliphatic polyols containing from about 2 to about 30 carbon atoms; and cycloaliphatics polyols containing from about 5 to about 6 ring carbon atoms. Specific examples of compounds within these classes are: ethylene glycol diacrylate and dimethacrylate, diethylene glycol diacrylate and dimethacrylate, triethylene glycol diacrylate and dimethacrylate, hexane diacrylate and dimethacrylate, trimethylolpropane triacrylate and trimethacrylate, dipentaerythritol pentaacrylate, pentaarcrylate, pentaerthrytol triacrylate, pentaerythrytol tetraacrylate and trimethacrylate, alkoxylated bisphenol-A diacrylates and dimethacrylates (e.g., ethoxylated bisphenol-A diacrylate and dimethacrylate and propoxylated bisphenol-A diacrylates and dimethacrylates) alkoxylated hexafluorobiphenol-A diacrylates and dimethacrylates and mixtures of the above compounds. Preferred monomers include multifunctional aryl acrylates and methacrylates. Preferred arylacrylate monomers include di-, tri-, and tetra-acrylates and methacrylates based on the bis-phenol-A structure. More preferred arylacrylate monomers are alkoxylated bisphenol-A diacrylates and dimethacrylates such as ethoxylated bisphenol-A diacrylates and dimethacrylates, and ethoxylated hexafluorobisphenol-A diacrylates and dimethacrylates.

Suitable oligomers include, but are not limited to, epoxy acrylate oligomers, aliphatic and aromatic urethane acrylate oligomers, polyester acrylate oligomers, and acrylated acrylic oligomers. Epoxy acrylate oligomers (such as Ebercryl 600 by Radcure) are preferred.

Suitable polymers include, but are not limited to, acrylated polyvinyl alcohols, polyester acrylates and methacrylates, and acrylated and methacrylated styrene-maleic acid co-polymers. Acrylated styrene-maleic acid copolymers are preferred.

When other ethylenically unsaturated monomers, oligomers or polymers are employed, the weight ratio of the monomer compounds of Formula I and II to the ethylemically unsaturated compounds may vary from about 1:9 to about 9:1, and preferably from about 1:1 to about 9:1.

Various optional additives may also be added to the curable compositions of the invention depending upon the application in which they are to be used. Examples of these optional additives include antioxidants, photostabilizers, volume expanders, fillers (e.g., silica and glass spheres), dyes, free radical scavengers, contrast enhancers and UV absorbers.

Antioxidants include such compounds as phenols and, particularly, hindered phenols, including Irganox 1010 from Ciba Specialty Chemicals; sulfides; organoboron compounds; organo-phosphorus compounds; and N, N′-hexamethylene-bis(3,5-di-tert-(butyl-4-hydroxyhydrocinnamamide)) available from Ciba Specialty Chemicals under the tradename Irganox 1098. Photostabilizers and more particularly hindered amine light stabilizers include, but are not limited to, poly[(6-hexamethylene)2,2,6,6-tetramethyl-4-piperidyl)imino)] available from Cytech Industries under the tradename Cyasorb UV3346. Volume expanding compounds include such materials as the spiral monomers known as Bailey's monomer. Suitable dyes include methylene green and methylene blue. Suitable free radical scavengers include oxygen, hindered amine light stabilizers, hindered phenols, and 2,2,6,6-tetramethyl-1-piperidinyloxy free radical (TEMPO). Suitable contrast enhancers include other free radical scavengers. UV absorbers include benzotriazoles and hydroxybenzophenone.

The additives may be used in amounts, based on the total composition weight, up to about 6%, and preferably from about 0.1% to about 1%. Preferably all components of the curable composition are an admixture with one another, and, preferably, in a substantially uniform admixture.

For purposes of the present invention, compositions that are curable by exposure to actinic radiation are defined as being “photocurable”. Suitable sources of actinic radiation include light in the visible, ultraviolet, or infrared regions of the spectrum, as well as electron beam, ion, neutron beam, or X-ray radiation. Actinic radiation may be in the form of incoherent light or coherent light such as light from a laser.

Photocurable compositions according to the present invention preferably contain a photoinitiator compound. Suitable photoinitiator compounds may be readily selected by those skilled in the art, and include, for example, DAROCUR 1173, DAROCUR 4265, IRGACURE 184, IRGACURE 261, IRGACURE 369, IRGACURE 500, IRGACURE 651, IRGACURE 784, IRGACURE 907, IRGACURE 1700, IRGACURE 2959, IRGACURE 1800, IRGACURE 1850, IRGACURE 819, AND IRGACURE 1300 (each commercially available from Ciba Specialty Chemicals) and GE-PI (commercially available from GE Corporation). The initiator is present in an amount sufficient to effect polymerization of the curable component. The initiator may comprise from about 0.01 to about 10% by weight, preferably from about 0.1 to about 6% by weight, and more preferably from about 0.5 to about 4% by weight of the total curable composition.

Photocurable compositions contain an amount of a photoinitiator within the foregoing ranges that is sufficient to effect photopolymerization of the photocurable component upon exposure to sufficient actinic radiation.

The photocurable compositions of the invention can be used in the formation of the light transmissive element of an optical device. Examples of such devices are planar optical slab waveguides, channel optical waveguides, ribbed waveguides, optical couplers, routers, combiners, and splitters.

The photocurable composition of the invention can also be used in the formation of negative working photoresists and other lithographic elements such as printing plates. In a preferred embodiment of the invention, the photocurable composition is used for producing a waveguide comprising a substrate containing a light transmissive element. Such waveguides are formed by applying a layer of the photocurable composition of invention to the surface of a suitable substrate. The layer may be formed by any method known in the art, such as spin coating, dip coating, slot coating, roller coating and evaporation.

The substrate may be any material on which it is desired to establish a waveguide including semiconductor materials such as silicon, silicon oxide, glass, gallium arsenide, polymers, or composite material. In the event the light transmissive region on the substrate is to be made from a photocurable material which has an index of refraction which is lower than that of the substrate, an intermediate buffer layer possessing an index of refraction which is lower than that of the substrate must be applied to the substrate before the photocurable composition is added. Otherwise, the light loss in the waveguide will be unacceptable. Suitable buffers are made from semiconductor oxides, lower refractive index polymers or spin on silicon dioxide glass materials.

Once a layer of the photocurable composition is applied to the substrate, actinic radiation is directed onto the layer in order to delineate the light transmissive region. That is, the position and dimensions of the light transmissive device are determined by the pattern of the actinic radiation upon the surface of the layer on the substrate. The photopolymers of the invention are conventionally prepared by exposing the photocurable composition to sufficient actinic radiation. For purposes of this invention, “sufficient actinic radiation” means light energy of the required wavelength, intensity and duration to produce the desired degree of polymerization action in the photocurable composition.

Sources of actinic light, exposure procedures, times, wavelengths, and intensities may vary widely depending upon the desired degree of polymerization, the index of refraction of the photopolymer, and other factors known to those of ordinary skill in the art. The selection and optimization of these factors are well known to those skilled in the art.

Preferably, the photochemical excitation be carried out with relatively short wavelengths (or high energy) radiation so that exposure to radiation normally encountered before processing (e.g., room lights) will not prematurely polymerize the polymerizable material. The energy necessary to polymerize the photocurable compositions of the invention generally ranges from about 5 mW/cm² to about 200 mW/cm² with typical exposure times ranging from 0.1 second to about 5 minutes.

After the photocurable composition has been polymerized to form a predetermined pattern on the surface of the substrate, the pattern is then developed to remove the non-image areas. Any conventional development method can be used such as flushing the non-irradiated composition with a solvent. Suitable solvents include polar solvents, such as alcohols and ketones. The most preferred solvents are acetone, methanol, tetrahydrofuran, and ethyl acetate.

While the preferred embodiment of the invention involves photocuring the photocurable composition, as noted above, one skilled in the art will appreciate that many variations of the method within the scope of the claims are possible depending upon the nature of the curable composition. For example, the composition may be heat-cured in an oven or through another heat source such as microwave radiation. Alternately, the composition may be cured using a Lewis Acid catalyst. Depending upon the particular use, the photocurable composition may be partially cured before its application to a surface and then fully cured once applied.

Since curable compositions of the present invention are useful in the manufacture of optical devices having light transmissive regions, another aspect of the present invention provides a process for producing an optical device employing the steps of: (a) applying a layer of the photocurable composition of the invention onto a substrate; (b) imagewise exposing the photocurable composition of the invention to actinic radiation to form exposed and non-exposed areas on the substrate; and (c) removing the imagewise non-exposed areas while leaving the imagewise exposed areas on the substrate.

Yet another aspect of the invention comprises the light transmissive component of a waveguide produced in the above-identified process.

According to the present invention, polymers are also provided comprising one or more divinyl ether repeating units, alone or with other repeating units, wherein the divinyl ether repeating units as polymerized have the formula depicted in Formulas III through VII, supra. In one preferred embodiment, polymer films are provided, such as a film used as a substrate for various materials such as coatings, inks, adhesives, integrated circuits, and the like. In another embodiment, such a film is used as a surface layer for a substrate of various materials such as metal foils, plastic sheets, paper, fibers, and the like.

To improve the physical characteristics of the film, various materials may be combined with the divinyl ether polymer, including defoaming agents, coating property improvers, viscosity-increasing agents, organic lubricants, antioxidants, unltraviolet absorbers, foaming agents, dyes, pigments, and the like. Further, the film may contain inorganic particles with a particulate size of, for example, 1 μm or less, preferably 0.5 μm or less, and more preferably 0.2 μm or less. Preferred examples of the materials constituting the particles include kaolin, silica, silica sol, calcium carbonate, titanium oxide, barium salt, alumina, molybdenum sulfide, carbon black, and zirconium compounds.

Although the thickness of the film is not intended to be restricted, it is usually 0.0001 μm to 1 mm, and preferably 0.2 μm to 0.2 mm.

### EXAMPLES

In order that the present invention may be more readily understood, reference is made to the following examples which are intended to be illustrative of the invention, but are not intended to be limiting in scope.

### Example 1

Addition of CF₃CH═CF₂ to Hydroxybutyl Vinly Ether (HBVE)

To a stirred mixture of CH₃CN (40 mL), hydroxybuytyl vinylether (HBVE) (log, 86 mmol), HO(CH₂)₄OCH═CH₂, and cesium carbonate (1 g, 3.0 mmol), under nitrogen atmosphere, was added CF₃CH═CF₂ (12.5 g, 0.95 mmol) drop-wise via a dry ice condenser (−78° C.) (can also be bubbled into the solution via gas sparger) in such a way that the temperature of reaction temperature did not rise above 30° C. After complete addition, the reaction mixture was stirred for 1 hour, poured into water (300 mL), mixed well and allowed to settle. The lower layer was separated, washed with brine (20 ml), and concentrated under reduced pressure (1-5 mm Hg) to afford the product as a colorless liquid (9.9 g, 40% yield). The ratio of CF₃CH═CFO(CH₂)₄OCH═CH₂ (cis/trans) to CF₃CH₂CF₂O(CH₂)₄OCH═CH₂ in the product was 3.3:1; no other product in any significant amount was evident by NMR analysis. The material was stored in a refrigerator (0-5° C.) for future use.

GC/MS data: m/e 228 (M⁺ for CF₃CH═CFO(CH₂)₄OCH═CH₂) (cis/trans) and m/e 248 (M⁺ for CF₃CH₂CF₂O(CH₂)₄OCH═CH₂). ¹⁹F and ¹H NMR spectra are consistent with the structures. ¹⁹F NMR data (vs CFCl₃ standard)

For cis CF₃CH═CF—O—(CH₂)₄—O—CH═CH₂:

δ=−56.7 (3F, dd, ⁴J_{FF}=13 Hz, ³J_{HF}=7 Hz) −78.0 (1F, qd, ⁴J_{FF}=13 Hz, ³J_{HF}=4Hz) ppm;

For trans CF₃CH═CF—O—(CH₂)₄—OCH═CH₂:

δ=−55.4 (3F, dd, ⁴J_{FF}=16 Hz, ³J_{HF}=7 Hz) −72.3 (1F, dq, ⁴J_{FF}=16 Hz, ³J_{HF}=28 Hz) ppm;

For CF₃CH₂CF₂—O—(CH₂)₄—O—CH═CH₂:

δ=−63.4 (3F, p, ⁴J_{FF}=3 Hz, ³J_{HF}˜7 Hz), −71.1 (2F, dq (overlaps to a sextet)) ppm.

Ratio of divinyl ether to monovinyl ether was 0.73:0.23 based on CF₃ integration in ¹⁹F NMR spectrum.

### EXAMPLE 2

Preparation of CF₃CH═CF—O(CH₂)₄O—CH═CH₂ (cis/trans) in Water with Sodium Hydroxide

Into a three necked round bottom flak equipped with a dry ice condenser (−78° C.), stirrer, and temperature sensor, was added 10.4 g (90 mmol) of hydroxybuytyl vinyl ether (HO(CH₂)₄OCH═CH₂), 50 mL of 2M aqueous NaOH solution (100 mmol), and 100 mg of Aliquat®336 (tricaprylmethylammonium chloride), under a nitrogen atmosphere. The reaction mixture in the flask was vigorously stirred and CF₃CH═CF₂ (12.5 g, 95 mmol) was added via a gas sparger in such a way that the temperature of reaction temperature did not rise above 32° C. After the addition was completed, the reaction mixture was stirred for 6 hours, and the organic and inorganic layers were allowed to settle. The lower layer was separated, washed with water (2×20 mL) and brine (20 ml), and then concentrated under reduced pressure (1-5 mm Hg) to afford CF₃CH═CF—O—(CH₂)₄—O—CH═CH₂ (cis/trans mixture) as a colorless liquid (14.6 g, 73% yield). Spectral data were consistent with the structure.

### EXAMPLE 3

Addition of CF₃CH═CF₂ to HOCH₂CH₂OH

To a stirred mixture of CH₃CN (40 mL), ethylene glycol (HOCH₂CH₂OH) (5 g, 81 mmol), and cesium carbonate (2 g, 6.0 mmol), under nitrogen atmosphere, was added to CF₃CH═CF₂ (24 g, 166 mmol) drop-wise via a dry ice condenser (−78° C.) (can also be bubbled into the solution via gas sparger) in such a way that the temperature of reaction temperature did not rise above 30° C. After complete addition, the reaction mixture was stirred for 1 hour, poured into water (200 mL), mixed well and allowed to settle. The lower layer was separated, washed with water (1×100 mL), followed by brine (20 ml), and concentrated under reduced pressure (20 mm Hg) to afford a 5.5 g product as a colorless liquid. GC/MS analysis indicated the following major compounds in the ratio˜2:1:1.
CF₃CH═CFO(CH₂)₂OCF₂CH₂CF₃, m/e at 306 (M⁺, C₈H₇F₉O₂);
CF₃CH═CFO(CH₂)₂OCF═CHCF₃, m/e at 286 (M⁺, C₈H₆F₈O₂); and
CF₃CH₂CF₂O(CH₂)₂OCF₂CH₂CF₃, m/e at 326 (M⁺, C₈H₈F₁₀O₂).

### EXAMPLES 4-8

By following the procedure described in Example 1 or 2, the following compounds were obtained from the reaction of CF₃—CH═CF₂ (HFC 1225) with the appropriate hydroxy vinyl ethers or diols:
(4) CF₃CH═CF—O—(CH₂)₂—O—CF═CHCF₃
(5) CF₃CH═CF—O—(CH₂)₄—O—CF═CHCF₃
(6) CF₃CH═CF—O—CH₂—(CF₂)ₙ—CH₂—O—CF═CHCF₃, wherein n is an integer from 1 to 16
(7) CF₃CH═CF—O—(CH₂)₂—O—CH═CH₂
(8) CF₃CH═CF—O—Z—O—CH═CH₂, wherein

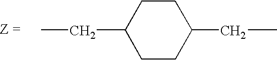

### EXAMPLES 9-13

By following the procedure described in Example 1, the following compounds were obtained from the reaction of CF₃—CH═CFH (HFC 1234) with the appropriate hydroxy vinyl ethers or diols:
(9) CF₃CH═CH—O—(CH₂)₂—O—CH═CH₂
(10) CF₃CH═CH—O—(CH₂)₄—O—CH═CH₂
(11) CF₃CH═CH—O—(CH₂)₂—O—CH═CHCF₃
(12) CF₃CH═CH—O—CH₂—(CF₂)ₙ—CH₂—O—CH═CHCF₃, wherein n is an integer from 1 to 16
(13) CF₃CH═CH—O—Z—O—CH═CH₂, wherein

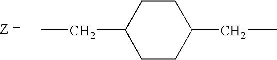

What is claimed is:

1. A fluorinated divinyl ether according to the formula R_{f}CX═CY—O—Z—O—CH═CH₂ or R_{f}CX═CY—O—M—O—CY═CXR_{f}, wherein
R_{f} is selected from the group consisting of fluorine and C₁- C₂₀ straight and branched-chain fluorinated alkyls;
X is selected from the group consisting of hydrogen, fluorine, chlorine, bromine, iodine, and straight and branched-chain C₁- C₂₀ fluorinated alkylenes;
Y is selected from the group consisting of hydrogen, fluorine, chlorine, bromine, iodine, and straight and branched-chain C₁-C₂₀ fluorinated alkylenes;
Z is selected from the group consisting of straight and branched-chain C₁- C₂₀ alkylenes, C₃-C₁₀ unsubstituted and substituted cycloalkylenes, four to ten ring member aromatic and non-aromatic heterocycloalkenes, C₆-C₁₅ unsubstituted and substituted arylenes, and C₇-C₂₀ unsubstituted and substituted arylalkylenes; and
M is selected from the group consisting of straight or branched-chain C₁-C₂₀ alkylenes, straight or branched-chain C₃-C₁₈ fluorinated alkylenes, provided that the chain does not terminate with —CFH— or —CF₂—, and C₃-C₁₈ diols having the formula —HO—CH₂—(CF₂)ₙ—CH₂—OH— wherein n is an integer from 1 to 16.

2. The fluorinated divinyl ether of claim 1 wherein
X and Y are independently selected from the group consisting of hydrogen, fluorine, chlorine, bromine, iodine, and trifluoromethylene;

3. The fluorinated divinyl ether of claim 1 wherein X is the same as Y.

4. The fluorinated divinyl ether of claim 1 wherein R_{f} is selected from the group consisting of fluoromethyl, difluoromethyl, trifluoromethyl, fluoroethyl, difluoroethyl, trifluoroethyl, pentafluoroethyl, perfluoropropyl, perfluorobutyl, perfluoropentyl, and perfluorohexyl.

5. The fluorinated divinyl ether of claim 1 wherein R_{f} is fluorine or trifluoromethyl.

6. The fluorinated divinyl ether of claim 1 wherein Z is selected from the group consisting of methylene, ethylene, n-propylene, isopropylene, n-butylene, isobutylene, tert-butylene, n-pentylene, neopentylene, n-hexylene, n-heptylene, n-octylene, and 2-ethylhexylene.

7. The fluorinated divinyl ether of claim 1 wherein Z is ethylene or butylene.

8. The fluorinated divinyl ether of claim 1 wherein Z is selected from the group consisting of cyclopropylene, cyclobutylene, cyclopentylene, methylcyclopentylene, cyclohexylene, methylcyclohexylene, dimethylcyclohexylene, cycloheptylene, and cyclooctylene.

9. The fluorinated divinyl ether of claim 8 wherein Z is 1,4-dimethylcyclohexyl.

10. The fluorinated divinyl ether of claim 1 wherein Z is selected from the group consisting of benzylene, phenylene, o-tolylene, m-tolylene, p-tolylene, o-xylylene, m-xylylene, p-xylylene, alpha-naphthylene, and beta naphthylene.

11. The fluorinated divinyl ether of claim 1 wherein Z is selected from the group consisting of 4-methylphenylene, o-methylphenylene, p-methylphenylene, diphenyl-methylene, 2-phenylethylene, 2-phenylpropylene, and 3-phenylpropylene.

12. The fluorinated divinyl ether of claim 1 wherein M is selected from the group consisting of methylene, ethylene, n-propylene, isopropylene, n-butylene, isobutylene, tert-butylene, n-pentylene, neopentylene, n-hexylene, n-heptylene, n-octylene, and 2-ethylhexylene.

13. The fluorinated divinyl ether of claim 1 wherein M is a straight chain C₁-C₆ alkylene.

14. The fluorinated divinyl ether of claim 1 wherein M is ethylene or butylene.

15. The fluorinated divinyl ether of claim 1 wherein M is —CH₂-(CF₂)ₙ—CH₂—, wherein n is an integer from 1 to 16.

16. The fluorinated divinyl ether of claim 1 wherein M is selected from the group consisting of 2-fluoropropylene, 2,3-difluorobutylene, 2,3,4-trifluoropentylene, 2,4-difluoropentylene, and 2,5-difluorohexylene.

17. The fluorinated divinyl ether of claim 1 wherein M is a C₃-C₁₈ diol having the formula —HO—CH₂—(CF₂)ₙ—CH₂—OH—, wherein n is an integer from 1 to 16.

18. The fluorinated divinyl ether of claim 1 wherein M is selected from the group consisting of 2,2,3,3-Tetrafluoro-1,4-butylenediol, 2,2,3,3,4,4-Hexafluoro-1,5-pentylenediol, and 2,2,3,3,4,4,5,5-Octafluoro-1 ,6-hexylenediol.

19. A fluorinated divinyl ether selected from the group consisting of:
CF₃CH═CF—O—CH₂—(CF₂)—CH₂—O—CF═CHCF₃,
CF₃CH═CF—O—CH₂—(CF₂)₂—CH₂—O—CF═CHCF₃,
CF₃CH═CF—O—CH₂—(CF₂)₃—CH₂—O—CF═CHCF₃,
CF₃CH═CH—O—CH₂—(CF₂)—CH₂—O—CH═CHCF₃,
CF₃CH═CH—O—CH₂—(CF₂)₂—CH₂—O—CH═CHCF₃, and
CF₃CH═CH—O—CH₂—(CF₂)₃—CH₂—O—CH═CHCF₃

20. A fluorinated divinyl ether selected from the group consisting of:
CF₃CH═CH—O—Z—O—CH═CH₂, CF₃CH═CF—O—Z—O—CH═CH₂, and
CF₃CH═CF—O—Z—O—CF═CHCF₃, wherein Z is selected from the group consisting of cyclopropylene, cyclobutylene, cyclopentylene, methylcyclopentylene, cyclohexylene, methylcyclohexylene, dimethylcyclohexylene, cycloheptylene, cyclooctylene, thiophene, pyrrole, furan, pyridine, pyran, phenylene, o-tolylene, m-tolylene, p-tolylene, o-xylylene, m-xylylene, p-xylylene, alpha-naphthylene, beta naphthylene, 4-methylbenzylene, o-methylbenzylene, p-methylbenzylene, diphenyl-methylene, 2-phenylethylene, 2-phenylpropylene, and 3-phenylpropylene.

21. A fluorinated divinyl ether selected from the group consisting of
CF₃CH═CF—O—(CH₂)₂—O—CH═CH₂,
CF₃CH═CF—O—(CH₂)₄—O—CH═CH₂,
CF₃CH═CF—O—(CH₂)₂—O—CF═CHCF₃,
CF₃CH═CF—O—(CH₂)₄—O—CF═CHCF₃,
CF₃CH═CH—O—(CH₂)₂—O—CH═CH₂,
CF₃CH═CH—O—(CH₂)₄—O—CH═CH₂, and
CF₃CH═CH—O—(CH₂)₂—O—CH═CHCF₃.

22. A curable composition comprising a curable component comprising at least one fluorinated divinyl ether according to claim 1.

23. The composition of claim 22, wherein R_{f} is fluorine or trifluoromethyl.

24. The composition of claim 22, wherein Z is selected from the group consisting of ethylene, butylene, and 1,4-dimethylcyclohexane.

25. The composition of claim 22, wherein M is selected form the group consisting of ethylene, butylene, and fluorinated alkylenes having the formula —CH₂—(CF₂)ₙ—CH₂—, wherein n is an integer from 1 to 16.

26. The composition of claim 22, wherein said curable component is present in an amount from about 0.01% to about 99% by weight of said composition.

27. The composition of claim 26, wherein said curable component is present in an amount from about 0.01% to about 2% by weight of said composition.

28. The composition of claim 26, wherein said curable component is present in an amount from about 35% to about 99% by weight of said composition.

29. The composition of claim 22, further comprising one or more additives selected from the group consisting of anti-oxidants, photostabilizers, volume expanders, fillers, dyes, free radical scavengers, contrast enhancers, UV absorbers and initiator compounds.

30. The composition of claim 22, further comprising at least one ethylenically unsaturated monomer, oligomer, or polymer compound, or at least one monomer, oligomer or polymer compound having a terminal epoxide group.

31. The composition of claim 29, wherein said initiator is a Lewis Acid catalyst.

32. The composition of claim 29, wherein said initiator is a photoinitiator compound.

33. A polymer comprising one or more divinyl ether repeating units independently selected from the group consisting of: 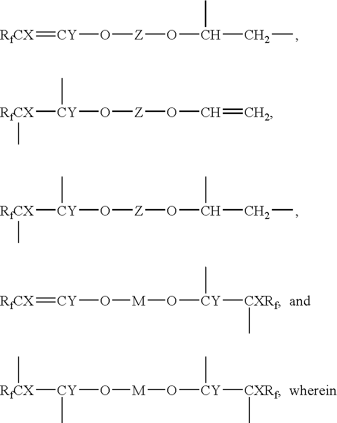
R_{f} is selected from the group consisting of fluorine and C₁- C₂₀ straight and branched-chain fluorinated alkyls;
X is selected from the group consisting of hydrogen, fluorine, chlorine, bromine, iodine, and straight and branched-chain C₁- C₂₀ fluorinated alkylenes;
Y is selected from the group consisting of hydrogen, fluorine, chlorine, bromine, iodine, and straight and branched-chain C₁-C₂₀ fluorinated alkylenes;
Z is selected from the group consisting of straight and branched-chain C₁- C₂₀ alkylenes, C₃-C₁₀ unsubstituted and substituted cycloalkylenes, four to ten ring member aromatic and non-aromatic heterocycloalkenes, C₆-C₁₅ unsubstituted and substituted arylenes, and C₇-C₂₀ unsubstituted and substituted arylalkylenes; and
M is selected from the group consisting of straight or branched-chain C₁-C₂₀ alkylenes, straight or branched-chain C₃-C₁₈ fluorinated alkylenes, provided that the chain does not terminate with —CFH— or —CF₂—, and C₃-C₁₈ diols having the formula —HO—CH₂—(CF₂)ₙ—CH₂—OH— wherein n is an integer from 1 to 16.

34. The polymer of claim 33 wherein R_{f} is fluorine or trifluoromethyl.

35. The polymer of claim 33 wherein Z is selected from the group consisting of ethylene, butylene, and 1,4-dimethylcyclohexylene.

36. The polymer of claim 33 wherein M is selected form the group consisting of ethylene, butylene, and —CH₂—(CF₂)ₙ—CH₂—, wherein n is an integer from 1 to 16.

37. The polymer of claim 33 wherein said polymer further comprises one or more additional repeating units selected from the group consisting of other monomers, oligomers, or polymer repeating units that have been co-polymerized with one or more of said divinyl ether repeating units.

38. The polymer of claim 33 consisting essentially of said divinyl ether repeating units.

39. A process for producing an optical device comprising the steps of:
(a) applying a layer of the photocurable composition of claim 32 onto a substrate;
(b) imagewise exposing the photocurable composition to actinic radiation to form exposed and non-exposed areas on the substrate; and
(c) removing the imagewise non-exposed areas while leaving the imagewise exposed areas on the substrate.

40. An optical device produced according to the process of claim 39.

41. The optical device of claim 40, further characterized as being a waveguide, splitter, router, coupler, combiner or any combination thereof.

42. The optical device of claim 40, wherein said substrate comprises silicon, a silicon oxide, gallium arsenide, glass, a polymer or a composite material.

43. An optical device comprising a substrate having light transmissive regions coated with a polymer according to claim 33.

44. A film comprising a polymer according to claim 33.

45. The film of claim 44, wherein said film is a substrate for a material selected from the group consisting of coatings, inks, integrated circuits, and adhesives.

46. The film of claim 44, wherein said film is a surface layer on a substrate comprising a material selected from the group consisting of metal foils, plastic sheets, paper, and fibers.

47. The film of claim 44 further comprising one or more materials selected from the group consisting of defoaming agents, coating property improvers, viscosity-increasing agents, organic lubricants, antioxidants, unltraviolet absorbers, foaming agents, dyes, pigments, and inorganic particles of one or more compounds selected from the group consisting of kaolin, silica, silica sol, calcium carbonate, titanium oxide, barium salt, alumina, molybdenum sulfide, carbon black, and zirconium compounds, wherein said particles have a diameter less than about 1 μm.

48. An article comprising a coating on a substrate, wherein said coating comprises a fluorinated divinyl ether according to claim 1, and wherein said substrate is selected from the group consisting of fibers, laminates, extruded shapes, molded shapes, forged shapes, structural polymers, paper, electronics, integrated circuits, integrated circuit manufacturing equipment, photoresists, electrical insulators, optical lenses, prisms, glazings, magnetic recording heads, magnetic data disks, optical data disks, magnetic data tapes, radio and microwave transmitters, radio and microwave receivers, radio and microwave antennas, and radio and microwave dishes.

49. An ink, dye, adhesive, elastomer, or foam comprising at least one polymer according to claim 33.

50. A process for the preparation of fluorinated divinyl ether according to the formula R_{f}CX═CY—O—Z—O—CH═CH₂ or R_{f}CX═CY—O—M—O—CY═CXR_{f}, wherein
R_{f} is selected from the group consisting of fluorine and C₁-C₂₀ straight and branched-chain fluorinated alkyls;
X is selected from the group consisting of hydrogen, fluorine, chlorine, bromine, iodine, and straight and branched-chain C₁-C₂₀ fluorinated alkylenes;
Y is selected from the group consisting of hydrogen, fluorine, chlorine, bromine, iodine, and straight and branched-chain C₁-C₂₀ fluorinated alkylenes;
Z is selected from the group consisting of straight and branched-chain C₁-C₂₀ alkylenes, C₃-C₁₀ unsubstituted and substituted cycloalkylenes, four to ten ring member aromatic and non-aromatic heterocycloalkenes, C₆-C₁₅ unsubstituted and substituted arylenes, and C₇-C₂₀ unsubstituted and substituted arylalkylenes; and
M is selected from the group consisting of straight or branched-chain C₁-C₂₀ alkylenes, straight or branched-chain C₃-C₁₈ fluorinated alkylenes, provided that the chain does not terminate with —CFH— or —CF₂—, and C₃-C₁₈ diols having the formula —HO—CH₂—(CF₂)ₙ—CH₂—OH— wherein n is an integer from 1 to 16;
comprising the step of reacting a hydroxyvinylether with a fluoroolefin in the presence of a phase transfer catalyst with an aqueous solution of an inorganic base wherein added organic solvents are absent from the reaction medium.

51. The process of claim 50, wherein the fluoroolefin has the formula R_{f}CX═CYW wherein X, Y, and W are independently selected from the group consisting of hydrogen, fluorine, chlorine, bromine, iodine, and C₁ to C₂₀ straight and branched-chain fluorinated alkylenes provided that at least one of Y or W is a halogen.

52. The process of claim 50, wherein the fluoroolefin is elected from the group consisting of CF₃CH═CF₂, CF₃CH═CFH, CF₃CF═CFH, CF₃CH═CHCI, CF₃CBr═CF₂, CF₃Cl═CHCl, CF₃(CF₂)ₙCF═CF₂ and CF₃(CF₂)ₙCF═CH, wherein n is an integer from 1 to 16.

53. The process of claim 50, wherein the inorganic base is selected from the group consisting of alkali metal hydroxides and alkaline earth metal hydroxides.

54. The process of claim 50, wherein the phase transfer catalyst is selected from the group consisting of crown ethers, cryptates, and onium salts.
